(19) United States
(12) Patent Application Publication
(10) Pub. No.: US 2012/0175940 A1
(43) Pub. Date: Jul. 12, 2012

(54) SLEEVE NUT

(75) Inventor: Ross S. Hill, Lansing, MI (US)

(73) Assignee: ILLINOIS TOOL WORKS INC., Glenview, IL (US)

(21) Appl. No.: 13/496,257

(22) PCT Filed: Sep. 9, 2010
(86) PCT No.: PCT/US2010/048210

§ 371 Date: Mar. 15, 2012

Related U.S. Application Data
(60) Provisional application No. 61/242,842, filed on Sep. 16, 2009.

(51) Int. Cl. B60B 3/16; B60B 19/00; F16B 37/00

(52) U.S. Cl. 301/6.1; 411/427

(57) ABSTRACT

A sleeve nut configured to properly align components of a wheel assembly includes a main body defining a central channel formed therethrough. The main body has first and second ends. The first end is configured to be retained within a through-hole of a brake drum connected to a hub. The second end is configured to be securely positioned between an outer circumference of a shaft of a fastener and a portion of the brake drum that defines the through-hole. The sleeve nut is configured to ensure that the fastener remains properly aligned with respect to the wheel assembly.

### RELATED APPLICATIONS

This application relates to and claims priority benefits from U.S. Provisional Patent Application No. 61/242,842 entitled “Sleeve Nut for Use in a Wheel Assembly,” filed Sep. 16, 2009, which is hereby incorporated by reference in its entirety.

### FIELD OF EMBODIMENTS OF THE INVENTION

Certain embodiments of the present invention provide a sleeve nut configured to hold a brake drum in a properly-aligned position with respect to a wheel assembly.

### BACKGROUND

Various vehicles utilize a hub-piloted flat mounting system with respect to a wheel assembly. When installing wheels on such a flat mounting system, an outboard brake drum is mounted on a drum pilot that is part of the hub. During installation, it may be difficult or impossible to determine if the drum has slipped off the pilot prior to the wheels being tightened. If the drum falls off the pad, the drum may be wedged and not properly seat on the pad(s). During vehicle operation, however, the brake drum may slip into its proper position on the pad, thereby causing the wheel assembly to become loose. In the worst-case scenario, this condition causes the wheel to separate from the vehicle.

### SUMMARY OF EMBODIMENTS OF THE INVENTION

Embodiments of the present invention provide a sleeve nut that ensures components of a wheel assembly are properly aligned during manufacture and operation.

Certain embodiments of the present invention provide a wheel assembly that includes a hub including a collar with a first through-hole formed therethrough, a brake drum connected to the hub, a sleeve nut, and a fastener. The brake drum includes a flange with a second through-hole formed therethrough. The first and second through-holes are aligned with one another. The sleeve nut includes a central channel. The sleeve nut has a first end aligned with the second through-hole. The fastener is secured within the first through-hole and extends into the second through-hole and through the central channel of the sleeve nut.

Certain embodiments of the present invention provide a wheel assembly that includes a hub, brake drum, sleeve nut, and a fastener. The hub includes a collar with a first through-hole formed therethrough. The brake drum connects to the hub, and includes a flange with a second through-hole formed therethrough. The first and second through-holes are aligned with one another.

The sleeve nut includes a central channel. The sleeve nut has a first end within the second through hole.

The fastener is secured within the first through-hole and extends into the second through-hole through the central channel of the sleeve nut. At least a portion of the sleeve nut is securely positioned between an outer circumference of a shaft of the fastener and a portion of the brake drum that defines the second through-hole. The sleeve nut ensures that the fastener remains properly aligned with respect to the wheel assembly.

The wheel assembly may also include an inner wheel connected to the brake drum. The inner wheel has a third through-hole aligned with the first and second through-holes. The fastener extends through the third through-hole.

A portion of the sleeve nut may be securely positioned between the outer circumference of the shaft of the fastener and a portion of the inner wheel that defines the third through-hole.

The wheel assembly may also include an outer wheel connected to the inner wheel. The outer wheel has a fourth through-hole aligned with the first, second, and third through-holes. The fastener extends through the fourth through-hole.

A portion of the sleeve nut may be securely positioned between the outer circumference of the shaft of the fastener and a portion of the outer wheel that defines the fourth through-hole.

The sleeve nut may include a main body having a ledge. A reduced-diameter rim extends from the ledge. The rim extends into the second-through hole.

At least a portion of the sleeve nut may have a cylindrical axial cross section. At least a portion of the sleeve nut may have a hexagonal axial cross section.

The sleeve nut may include a cylindrical main body having notches formed at a second end that is opposite the first end.

At least a portion of an interior wall that defines the central channel of the sleeve nut may be threaded.

Certain embodiments of the present invention provide a sleeve nut configured to properly align components of a wheel assembly. The sleeve nut includes a main body defining a central channel formed therethrough. The main body has first and second ends. The first end is configured to be retained within a through-hole of a brake drum connected to a hub. The second end is configured to be securely positioned between an outer circumference of a shaft of a fastener and a portion of the brake drum that defines the through-hole. The sleeve nut is configured to ensure that the fastener remains properly aligned with respect to the wheel assembly.

### BRIEF DESCRIPTION OF SEVERAL VIEWS OF THE DRAWINGS

FIG. 1 illustrates an isometric first end view of a sleeve nut, according to an embodiment of the present invention.

FIG. 2 illustrates an isometric second end view of a sleeve nut, according to an embodiment of the present invention.

FIG. 3 illustrates an axial cross-sectional view of a sleeve nut, according to an embodiment of the present invention.

FIG. 4 illustrates an isometric first end view of a sleeve nut, according to an embodiment of the present invention.

FIG. 5 illustrates an isometric second end view of a sleeve nut, according to an embodiment of the present invention.

FIG. 6 illustrates an axial cross-sectional view of a sleeve nut, according to an embodiment of the present invention.

FIG. 7 illustrates an isometric top view of a hub, according to an embodiment of the present invention.

FIG. 8 illustrates an isometric top view of a brake drum overlaying a hub, according to an embodiment of the present invention.

FIG. 9 illustrates an isometric top view of a sleeve nut connected to a brake drum, according to an embodiment of the present invention.

FIG. 10 illustrates an isometric top view of an inner wheel positioned over a brake drum and hub, according to an embodiment of the present invention.

FIG. 11 illustrates an isometric top view of an outer wheel positioned over an inner wheel, according to an embodiment of the present invention.

FIG. 12 illustrates an isometric top view of an outer wheel securely fastened to an inner wheel, brake drum, and hub, according to an embodiment of the present invention.

FIG. 13 illustrates a partial cross-sectional view of an outer wheel securely fastened to an inner wheel, brake drum, and hub, according to an embodiment of the present invention.

FIG. 14 illustrates an isometric top view of a sleeve nut, according to an embodiment of the present invention.

FIG. 15 illustrates a top plan view of a sleeve nut, according to an embodiment of the present invention.

FIG. 16 illustrates an axial cross-sectional view of a sleeve nut, according to an embodiment of the present invention.

FIG. 17 illustrates an isometric view of a sleeve nut engaging tool, according to an embodiment of the present invention.

FIG. 18 illustrates a top plan view of a sleeve nut engaging tool, according to an embodiment of the present invention.

FIG. 19 illustrates a side view of a sleeve nut engaging tool, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

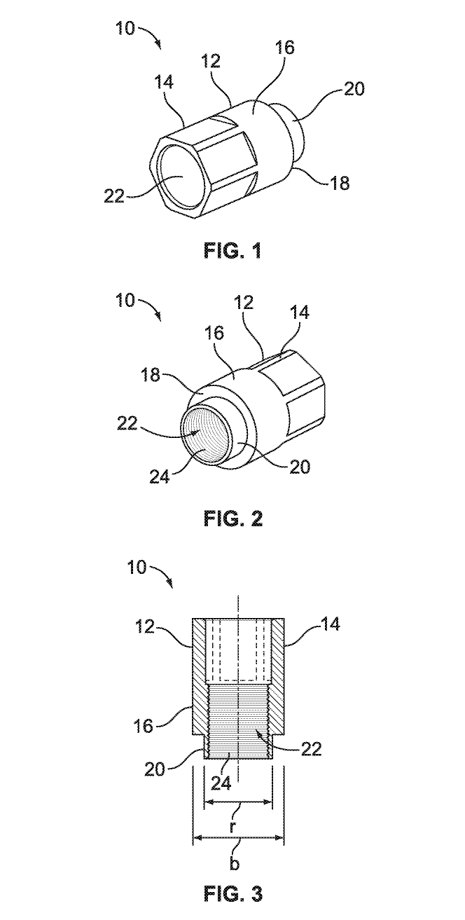

FIGS. 1 and 2 illustrate isometric first and second end views, respectively of a sleeve nut 10, according to an embodiment of the present invention. FIG. 3 illustrates an axial cross-sectional view of the sleeve nut 10.

Referring to FIGS. 1-3, the sleeve nut 10 includes a main body 12 having a hexagonal end 14 integrally connected to a round, cylindrical end 16. The cylindrical end 16 terminates at a ledge 18. A reduced-diameter cylindrical rim 20 extends outwardly from the ledge 18. The rim 20 has a smaller outer diameter than the ends 14 and 16.

An open-ended fastener channel 22 extends through the entire length of the main body 12, from the end 14 to the rim 20. As shown in FIGS. 1 and 3, the channel 22 is generally smooth through the end 14. The channel 22 is, however, threaded 24 through the rim 20 and the end 16. The smooth and threaded interior portions may or may not be aligned with exterior features. The threaded 24 portion of the channel 22 is configured to threadably engage a threaded fastener, such as a bolt.

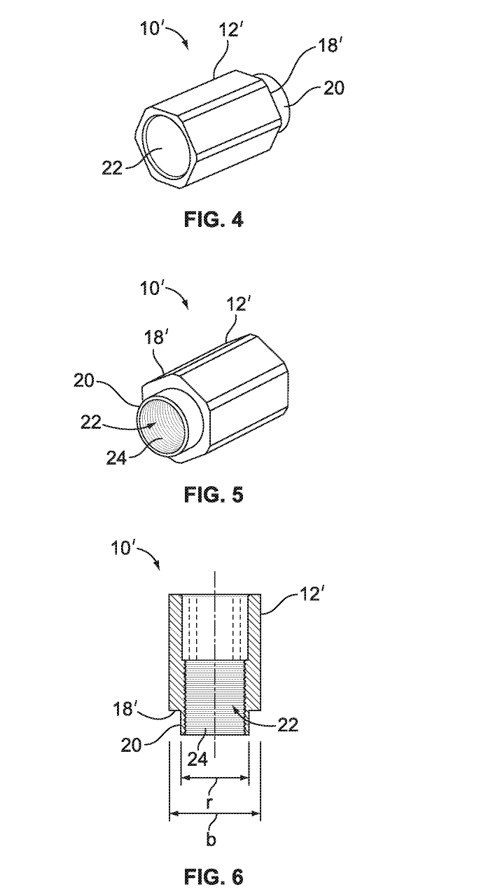

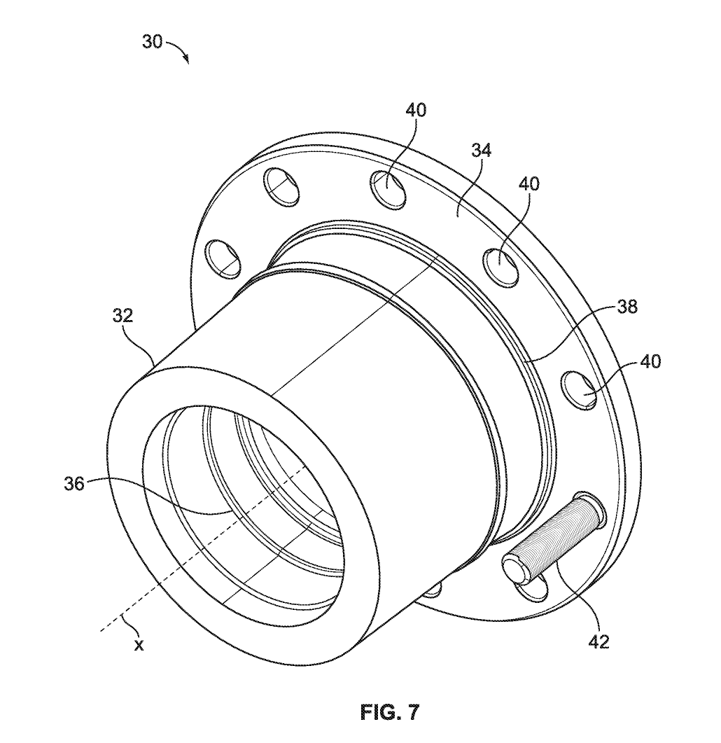

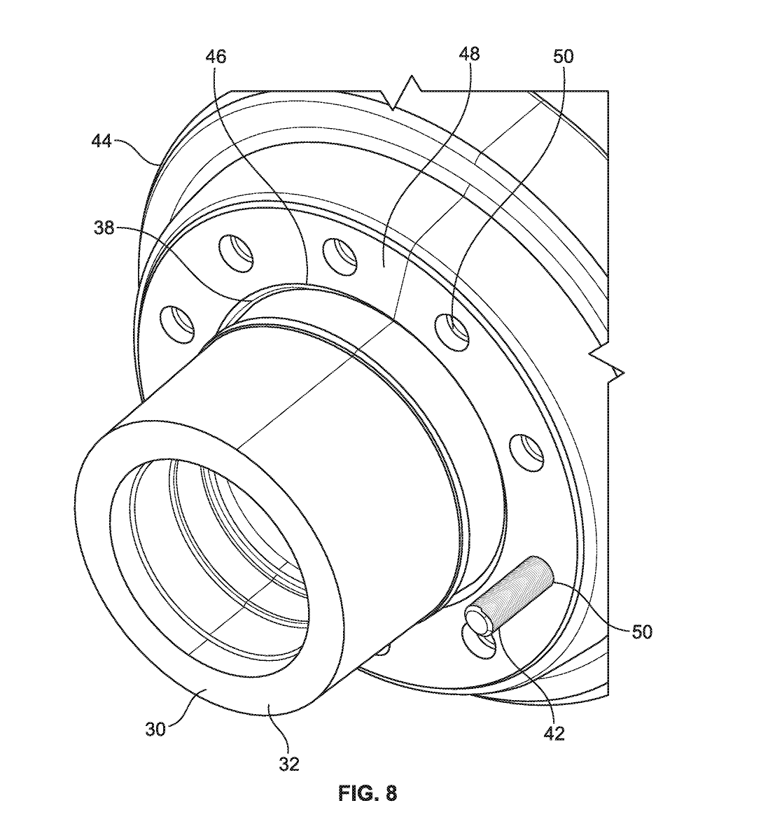

FIGS. 4 and 5 illustrate isometric first and second end views, respectively, of a sleeve nut 10′, according to an embodiment of the present invention. FIG. 6 illustrates an axial cross-sectional view of the sleeve nut 10′.

Referring to FIGS. 4-6, the sleeve nut 10′ is the same as the sleeve nut 10, except that the main body 12′ is entirely hexagonal, with the rim 20 extending from a hexagonal ledge 18′, instead of a circular ledge 18 (as shown in FIGS. 1-3).

Optionally, the main body 12 (shown in FIG. 1-3) or 12′ (shown in FIGS. 4-6) may be a smooth, round cylinder, such as the end 16 (shown in FIGS. 1-3). As shown in FIGS. 1-6, the outer diameter r of the rim 20 is less than the outer diameter b of the main body 12 or 12′.

FIG. 7 illustrates an isometric top view of a hub 30, according to an embodiment of the present invention. The hub 30 includes a central post 32 extending from a circumferential, planar collar 34. The collar 34 extends radially away from a central axis x of the hub 30. A central passage 36 extends through the post 32 and the collar 34 about the central axis x. A ridge 38, which may be fully contiguous or intermittent about the circumference, extends around the post 32 at the junction with the collar 34 and acts as a brake drum pilot, discussed below.

A plurality of through-holes 40 are formed through and around the collar 34. As shown in FIG. 7, a fastener 42, such as a threaded bolt, is received within a through-hole 40.

FIG. 8 illustrates an isometric top view of a brake drum 44 overlaying the hub 30, according to an embodiment of the present invention. The brake drum 44 includes a central opening 46 that passes over the central post 32 of the hub 30. Interior edges of the brake drum 44 that define the opening 46 abut into the ridge 38, which acts as a drum pilot that properly aligns and secures the brake drum 44 around the post 32 of the hub 30.

The brake drum 44 also includes a generally planar flange 48 that overlays the collar 34 (shown in FIG. 7) of the hub 30. The flange 48 includes a plurality of through-holes 50 that align over the through-holes 40 (shown in FIG. 7) of the hub 30. In this manner, the fastener 42 extends through aligned through-holes 40 and 50. Each through-hole 40 has a smaller diameter than that of a through-hole 50. Accordingly, there may be more clearance between the outer circumference of the fastener 42 and the through-hole 50 than there is between the outer circumference of the fastener 42 and the through-hole 40. Generally, however, the fastener 42 is press-fit into the through-hole 40.

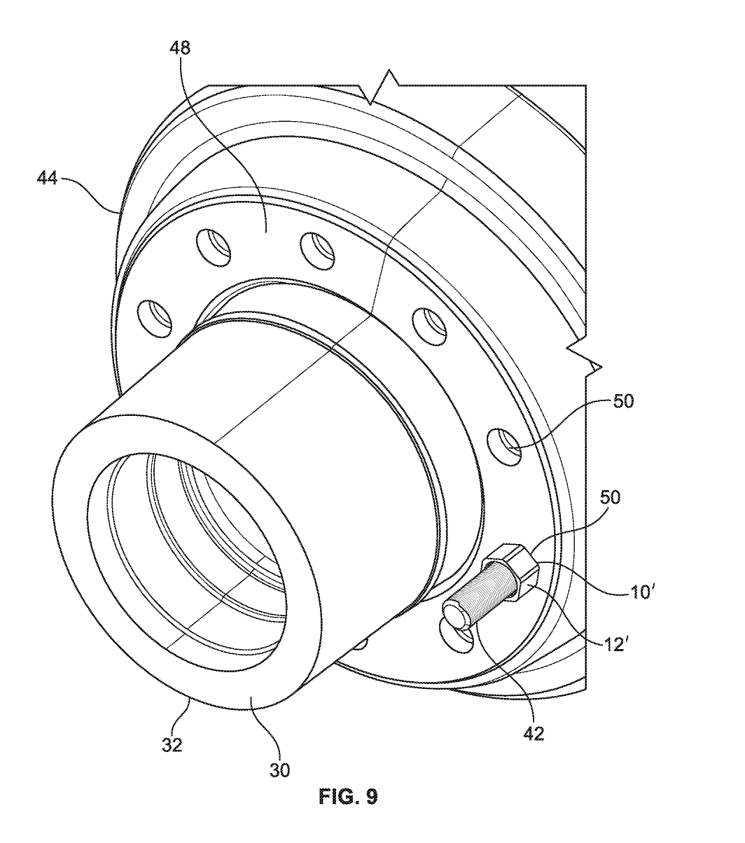

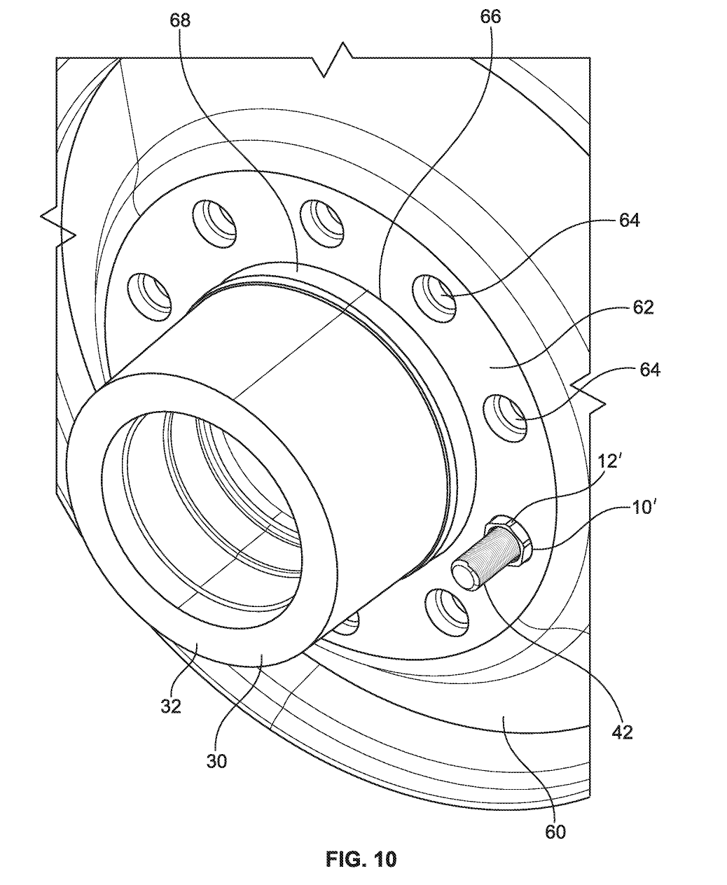

FIG. 9 illustrates an isometric top view of a sleeve nut 10′ connected to the brake drum 44, according to an embodiment of the present invention. While the sleeve nut 10′ is shown in FIG. 9, it is understood that the sleeve nut 10 may also be used.

Referring to FIGS. 4-6 and 9, in order to secure the sleeve nut 10′ around the fastener 42, the rim 20 (hidden from view in FIG. 9) is aligned over the exposed end of the fastener 42. The threads 24 (hidden from view in FIG. 9) threadably engage the threaded surface of the fastener 42. The sleeve nut 10′ is then rotatably urged toward the brake drum 44. As the sleeve nut 10′ approaches the brake drum 44, the rim 20 passes into the through-hole 50, as the outer diameter r of the rim 20 of the sleeve nut 10′ is slightly less than the diameter of the through-hole 50 of the brake drum 44. The rim 20 of the sleeve nut 10′ is configured such that it may be sandwiched between an outer circumference of the fastener 42 and interior edges of the flange 48 that define the through-hole 50. The sleeve nut 10′ continues to be urged into the through-hole 50 until the ledge 18′ (shown in FIGS. 4-6) abuts into the top surface of the flange 48 around the through-hole 50.

Thus, the reduced diameter rim 20 of the sleeve nut 10′ prevents the fastener 42 from axially shifting with respect to the through-hole 50 of the brake drum 44. The rim 20 may occupy any clearance space between the interior edges of the flange 48 that define the through-hole 50 and the outer circumference of the fastener 42. In this manner, the sleeve nut 10′ (or 10) ensures that the fastener 42 is properly aligned with respect to the through-hole 50, and additional through-holes of other wheel assembly components, as described below.

FIG. 10 illustrates an isometric top view of an inner wheel 60 positioned over the brake drum 44 and the hub 30, according to an embodiment of the present invention. The inner wheel 60 fits over the post 32 of the hub 30 similar to the brake drum 44. The inner wheel 60 includes a flange 62 that defines a plurality of through-holes 64 that align over the through-holes 50 (shown in FIGS. 8 and 9) and 40 (shown in FIG. 7). The main body 12′ (or 12) of the sleeve nut 10′ (or 10) may be securely positioned between interior edges of the flange 62 that define the through-hole 64 and the outer circumference of the fastener 42, in order to ensure that the fastener 42 is properly aligned with respect to the inner wheel 60. Optionally, a clearance area may exist between the main body 12′ (or 12) and the interior edges of the flange 62 that define the through-hole 64, in order to allow for desired wheel functioning. Similarly, a clearance area may exist between the rim 20 of the sleeve nut 10′ and the through-hole 50 of the brake drum 44.

Additionally, a circumferential edge 66 that defines a central passage of the flange 62 may abut into a band 68, which may be circumferential or intermittent, of the post 32 of the hub 30 in order to properly secure and align the inner wheel 60 with respect to the hub 30.

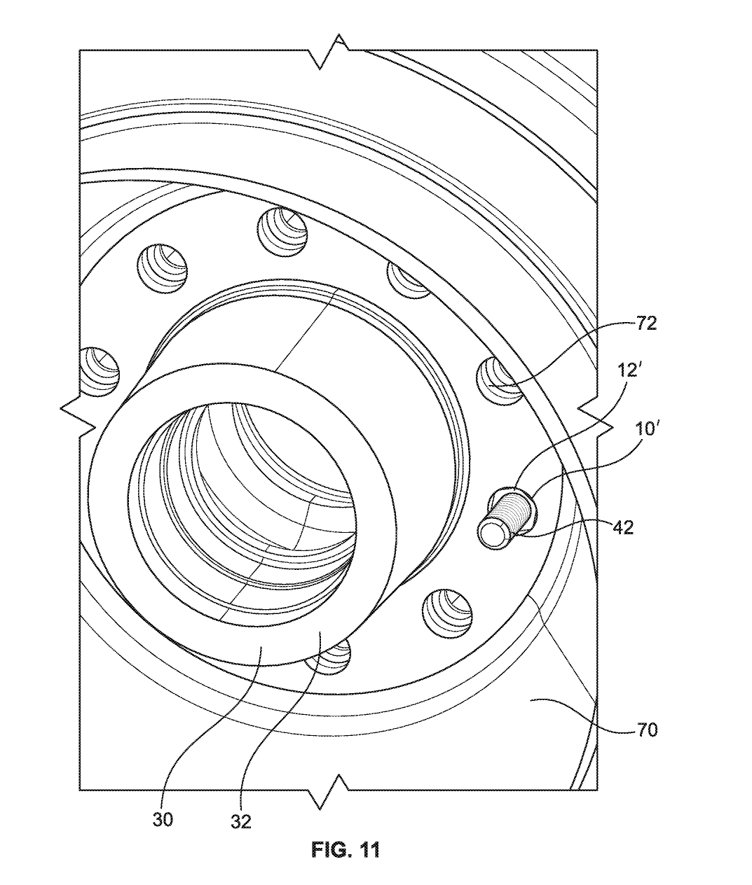

FIG. 11 illustrates an isometric top view of an outer wheel 70 positioned over the inner wheel 60, according to an embodiment of the present invention. The outer wheel 70 connects to the inner wheel 60 in a similar manner as the inner wheel 60 connects to the brake drum 44. The sleeve nut 10′ may not extend all the way through the through-hole 72. Instead, the sleeve nut 10′ may be recessed within the through-hole 72. In this manner, the sleeve nut 10′ does not interfere with a securing nut.

FIG. 12 illustrates an isometric top view of the outer wheel 70 securely fastened to the inner wheel 60 (hidden from view), brake drum 44 (hidden from view), and hub 30. A nut 80 securely fastens the components of the resulting wheel assembly together.

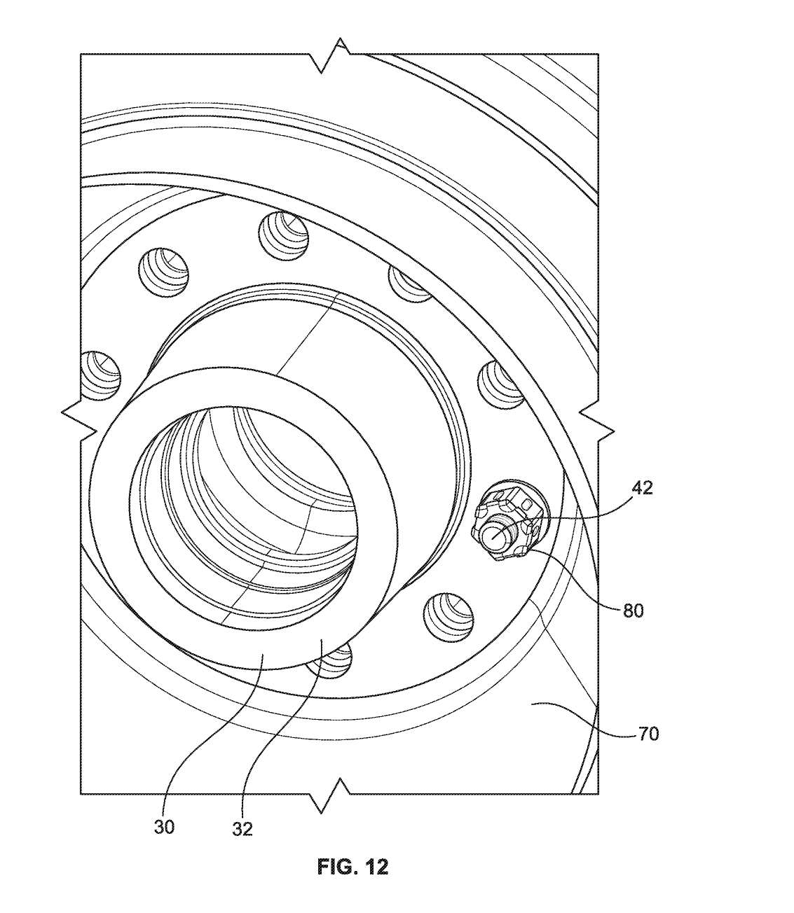

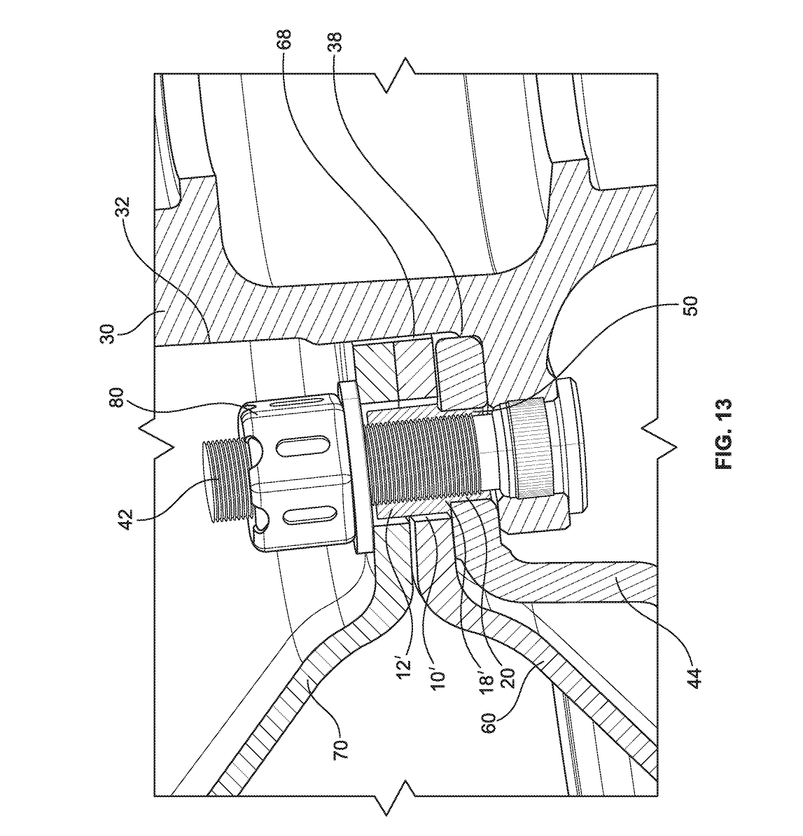

FIG. 13 illustrates a partial cross-sectional view of the outer wheel 70 securely fastened to the inner wheel 60, brake drum 44, and hub 30, according to an embodiment of the present invention. As shown, the rim 20 is securely positioned within the through-hole 50 of the brake drum 44, thereby ensuring that the brake drum 44 is properly aligned with respect to the hub 30, the inner wheel 60 and the outer wheel 70. The inner edges of the inner and outer wheels 60 and 70 that define their respective central passages abut into the circumferential band 68 of the central post 32 of the hub 30, thereby ensuring that the inner and outer wheels 60 and 70 are properly aligned with respect to the hub 30. The brake drum 44 is centered about the ridge 38 of the hub 30.

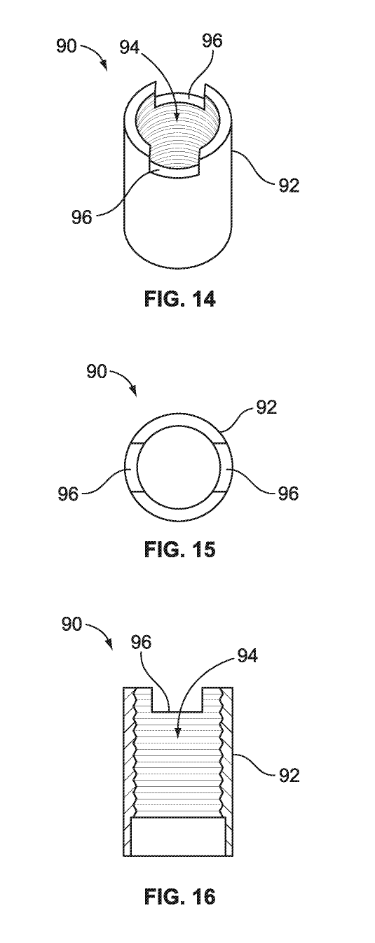

FIG. 14 illustrates an isometric top view of a sleeve nut 90, according to an embodiment of the present invention. FIG. 15 illustrates a top plan view of the sleeve nut 90. FIG. 16 illustrates an axial cross-sectional view of the sleeve nut 90.

Referring to FIGS. 14-16, the sleeve nut 90 includes a cylindrical main body 92 having a central channel 94 formed therethrough. At least a portion of the central channel 94 may be threaded, similar to the sleeve nuts 10 and 10′. The outer circumference of the main body 92 is generally uniform and may be generally the same diameter as the cylindrical end 16 of the sleeve nut 10, for example (shown in FIGS. 1-3). The sleeve nut 90 may thus be configured to be prevented from moving into the through-hole 50 (shown in FIG. 8) of the brake drum 44 (also shown in FIG. 8). Accordingly, the sleeve nut 90 acts as a securing device. Optionally, the sleeve nut 90 may be configured to be inserted into the through-hole 50 of the brake drum 44.

If the embodiment in which the sleeve nut 90 does not fit into the through-hole 50, the sleeve nut 90 generally does not center the brake drum 44. A securing nut then fastens directly to the face of the drum 44.

At an upper end, opposing notches 96 are formed. The notches 96 are configured to receive engagement barbs of a tool, shown and described with respect to FIGS. 17-19.

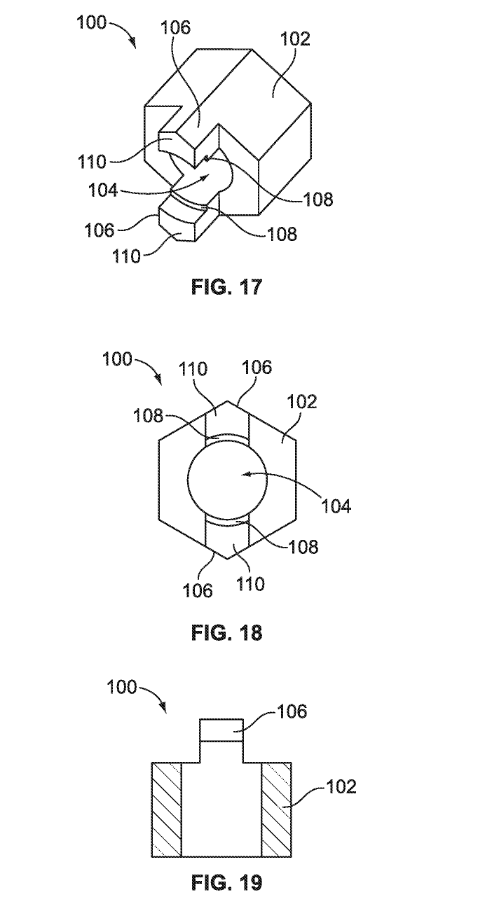

FIG. 17 illustrates an isometric view of a sleeve nut engaging tool 100, according to an embodiment of the present invention. FIG. 18 illustrates a top plan view of the sleeve nut engaging tool 100. FIG. 19 illustrates a side view of the sleeve nut engaging tool 100.

Referring to FIGS. 17-19, the tool 100 includes a main hexagonal body 102 having a central passage 104 formed therethrough. Opposing barbs 106 extend from upper surfaces of the main body 102 about the central passage 104. Each barb 106 includes a recessed ridge 108 integrally formed with an outer beam 110. As shown in FIGS. 17 and 18, in particular, the ridges 108 are closer to the central axis of the tool 100 than the beams 110.

Referring to FIGS. 14-19, in order to engage the sleeve nut 90, the tool 100 is aligned over the sleeve nut 90 such that the barbs 106 are aligned over the notches 96. The tool 100 is then urged into the sleeve nut 90 so that the ridges 108 rest on upper edges of the main body 92 that define the notches 96 and the beams 110 abut into an outer portion of the main body 92, below the notches 96 (as oriented in FIG. 14, for example). In this position, the barbs 106 also are wedged between lateral edges of the main body 92 that also define the notches 96. Another tool, such as a small impact wrench, may be used to torque the tool 100 and, therefore, the sleeve nut 90 into an engaging position.

As explained above, embodiments of the present invention provide a sleeve nut that aligns a fastener within a brake drum, and secures the fastener from undesirable axial and radial movement. Further, the sleeve nut may include an expanded main body (relative to a rim) that secures the fastener against undesirable axial and radial movement with respect to inner and outer wheels.

Embodiments of the present invention provide a sleeve nut that acts as a fastener that holds brake drums in their proper location on flat mounting wheel system wheel ends. As noted above, the external diameters of the sleeve nuts act as wheel centering devices. For example, three sleeve nuts may be used to secure the brake drum to the drum pilot of the hub. The external diameter of the sleeve nut acts as a centering device for the wheel. As such, clearance between the wheel bolt holes and the wheel stud are decreased (as compared to prior systems), thereby maintaining wheel integrity. That is, the tighter tolerance reduces momentum caused by the wheels tending to move back and forth on the fasteners.

Additionally, the sleeve nuts prevent damage to fasteners during wheel installation. The sleeve nuts hold the wheels off the threads, thereby helping to minimize damage to the threads.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A wheel assembly comprising:
a hub including a collar with a first through-hole formed therethrough;
a brake drum connected to said hub, said brake drum including a flange with a second through-hole formed therethrough, wherein said first and second through-holes are aligned with one another;
a sleeve nut including a central channel, said sleeve nut having a first end aligned with said second through-hole; and
a fastener secured within said first through-hole and extending into said second through-hole and through said central channel of said sleeve nut.

2. The wheel assembly of claim 1, wherein said first nut of said sleeve nut extends into said second through-hole, wherein at least a portion of said sleeve nut is securely positioned between an outer circumference of a shaft of said fastener and a portion of said brake drum that defines said second through-hole, and wherein said sleeve nut ensures that said fastener remains properly aligned with respect to the wheel assembly.

3. The wheel assembly of claim 1, comprising an inner wheel connected to said brake drum, said inner wheel having a third through-hole aligned with said first and second through-holes, wherein said fastener extends through said third through-hole.

4. The wheel assembly of claim 3, wherein a portion of said sleeve nut is securely positioned between the outer circumference of said shaft of said fastener and a portion of said inner wheel that defines said third through-hole.

5. The wheel assembly of claim 3, comprising an outer wheel connected to said inner wheel, said outer wheel having a fourth through-hole aligned with said first, second, and third through-holes, wherein said fastener extends through said fourth through-hole.

6. The wheel assembly of claim 5, wherein a portion of said sleeve nut is securely positioned between the outer circumference of said shaft of said fastener and a portion of said outer wheel that defines said fourth through-hole.

7. The wheel assembly of claim 1, wherein said sleeve nut comprises a main body having a ledge, wherein a reduced-diameter rim extends from said ledge, and wherein said rim extends into said second through-hole.

8. The wheel assembly of claim 1, wherein at least a portion of said sleeve nut has a cylindrical axial cross section.

9. The wheel assembly of claim 1, wherein at least a portion of said sleeve nut has a hexagonal axial cross section.

10. The wheel assembly of claim 1, wherein said sleeve nut comprises a cylindrical main body having notches formed at a second end that is opposite the first end.

11. The wheel assembly of claim 1, wherein at least a portion of an interior wall that defines said central channel is threaded.

12. A sleeve nut configured to properly align components of a wheel assembly, the sleeve nut comprising:
a main body defining a central channel formed therethrough, said main body having first and second ends, wherein said first end is configured to be retained within a through-hole of a brake drum connected to a hub,
wherein said second end is configured to be securely positioned between an outer circumference of a shaft of a fastener and a portion of the brake drum that defines the through-hole, and wherein said sleeve nut is configured to ensure that the fastener remains properly aligned with respect to the wheel assembly.

13. The sleeve nut of claim 12, wherein said main body comprises a ledge, and a reduced-diameter rim extending from said ledge, wherein said rim is configured to be retained within the second through-hole.

14. The sleeve nut of claim 12, wherein at least a portion of said main body has a cylindrical axial cross section.

15. The sleeve nut of claim 12, wherein at least a portion of said sleeve nut has a hexagonal axial cross section.

16. The sleeve nut of claim 12, wherein said main body is cylindrical and includes notches formed at said second end.

17. The sleeve nut of claim 12, wherein at least a portion of an interior wall that defines said central channel is threaded.

18. A wheel assembly comprising:
a hub including a collar with a plurality of first through-holes formed therethrough;
a brake drum connected to said hub, said brake drum including a flange with a plurality of second through-holes formed therethrough, wherein said plurality of first through-holes and said plurality of second through-holes are aligned with one another;
a plurality of sleeve nuts, each of said plurality of sleeve nuts including a central channel, wherein at least a portion of an interior wall that defines said central channel is threaded, each of said plurality of sleeve nuts having a first end within one of said plurality of second through holes;
a plurality of fasteners, each of said plurality of fasteners being secured within one of said plurality of first through-holes and extending into one of said plurality of second through-holes through one of said plurality of sleeve nuts, wherein at least a portion of each of said sleeve nuts is securely positioned between an outer circumference of a shaft of one of said plurality of fasteners and portions of said brake drum that define said plurality of second through-holes, and wherein said plurality of sleeve nuts ensure that said plurality of fasteners remain properly aligned with respect to the wheel assembly;
an inner wheel connected to said brake drum, said inner wheel having a plurality of third through-holes aligned with said plurality of first through-holes and said plurality of second through-holes, wherein each of said plurality of fasteners extend through one of said plurality of third through-holes; and
an outer wheel connected to said inner wheel, said outer wheel having a plurality of fourth through-holes aligned with said plurality of first, second, and third through-holes, wherein each of said plurality of fasteners extends through one of said plurality of fourth through-holes.

19. The wheel assembly of claim 18, wherein a portion of each of said plurality of sleeve nuts is securely positioned between the outer circumference of said shaft of one of said plurality of fasteners and a portion of said inner wheel that defines one of said plurality of third through-holes.

20. The wheel assembly of claim 18, wherein a portion of each of said sleeve nuts is securely positioned between the outer circumference of said shaft of each of said plurality of fasteners and a portion of said outer wheel that defines each of said plurality of fourth through-holes.

21. The wheel assembly of claim 18, wherein each of said plurality of sleeve nuts comprises a main body having a ledge, wherein a reduced-diameter rim extends from said ledge, and wherein said rim extends into one of said plurality of second through-holes.

22. The wheel assembly of claim 18, wherein each of said plurality of sleeve nuts comprises a cylindrical main body having notches formed at a second end that is opposite the first end.
